(19) United States
(12) Patent Application Publication
(10) Pub. No.: US 2022/0021839 A1
(43) Pub. Date: Jan. 20, 2022

(54) Decorative Television Frame

(71) Applicant: Alma Washington, North Charleston, SC (US)

(72) Inventor: Alma Washington, North Charleston, SC (US)

(21) Appl. No.: 17/371,771

(22) Filed: Jul. 9, 2021

Related U.S. Application Data
(60) Provisional application No. 63/051,962, filed on Jul. 15, 2020.

(51) Int. Cl. H04N 5/64

(52) U.S. Cl. CPC H04N 5/64; G09F 23/00

(57) ABSTRACT

The present invention relates to a display device bezel cover. The display device bezel cover may be used as a decorative and protective frame, and positioned on the front viewing surface of the screen bezel of a display device or any other electronic device to provide a customized look. More specifically, the cover features four generally rectilinear arm lengths or sections made up of a relatively soft material. Each arm section includes a front viewing surface and a rear mounting surface, wherein the rear mounting surface includes a plurality of self-adhesive tape sections along the length of the arm thereby allowing the arm to be removably attached to the screen bezel edge. The front viewing surface can include a design or a logo to provide a decorative look to the screen bezel.

### CROSS-REFERENCE TO RELATED APPLICATION

The present application claims priority to, and the benefit of, U.S. Provisional Application No. 63/051,962, which was filed on Jul. 15, 2020 and is incorporated herein by reference in its entirety.

### FIELD OF THE INVENTION

The present invention relates generally to the field of decorative panels. More specifically, the present invention relates to a decorative frame for the exterior of a television or electronic monitor for enhancing and customizing its appearance. Additionally, the decorative frame of the present invention utilizes soft foam material to ensure the television does not overheat when the frame is in use. The decorative frame personalizes the look of the television and offers a convenient way for people to express themselves through home decoration. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, televisions are used in almost every home and people depend on television for entertainment, news, education, culture, weather, sports, music and more. Generally, people that own televisions have them installed in their living room area or other rooms, surrounded by other home decor. Once a television of a specific look and design is bought, individuals may not change the television for a minimum period of 8 to 10 years or until the television becomes damaged or irreparable. Conventional televisions include a frame or screen bezel that typically is lacking in color and results in a ‘look’ that is boring and uninspiring for the users. Also, the television screen bezel is usually kept plain and simple by the manufacturers to suit the requirements of most of the users. However, some individuals have desires to enhance the ‘look’ of their television and associated screen bezel in order to add to the decoration of same and/or to coordinate the screen bezel to the décor of the room in which the television resides.

Additionally, individuals may have a desire to decorate and customize the look of their television to coordinate with the interior decoration of their living room or other area where the television is placed. However, this is nearly impossible presently as televisions are manufactured with limited look variations generally available in the present-day marketplace.

It has been shown that individuals spend about 4 to 5 hours daily watching television, and many people spend about two to three hours of uninterrupted continuous viewing to watch daily shows, movies, sports and more. When the television is used for longer periods of uninterrupted continuous viewing, the television can easily become overheated, thereby heating internal components of the television, and damaging the television as a whole. In such scenarios, people are required to turn OFF the television to allow the device to cool down. People may get annoyed in such situations when they are unable to watch their favorite shows, movies, sports and more due to overheating issues in televisions.

Therefore, there exists a long felt need in the art for a device that allows the users to change the look of their televisions, or electronic monitors, as per their desires. There is also a long felt need in the art for a device that allows the users to decorate and customize the look of the conventional television installed in any room of a home. Additionally, there is a long felt need in the art for a device that allows the users to personalize the look of the television to match to the interior decor of the room. Moreover, there is a long felt need in the art for a device that allows the users to change the plain and simple look of televisions in a convenient manner. Further, there is a long felt need in the art for a device that eliminates the need to buy a new television to have an enhanced appearance of the television. Furthermore, there is a long felt need in the art for a device that prevents the television from getting overheated and allows the users to easily watch their favorite shows for longer periods of time. Finally, there is a long felt need in the art for a device that is portable, easy to use, and provides a convenient solution for people to express themselves through home decoration.

The subject matter disclosed and claimed herein, in one embodiment thereof, comprises a display device or screen bezel cover. The display device or screen bezel cover is configured to be a decorative frame and positioned on the front viewing surface of an electronic screen bezel, or electronic monitor bezel, to provide a customized look to the screen bezel. The display device bezel cover further comprises four generally rectilinear arm lengths made up of a soft material. Each arm includes a front viewing surface and a rear mounting surface. The rear mounting surface includes a plurality of self-adhesive tapes along the length of the arm to removably attach to the screen bezel edge. The front viewing surface includes a design or a logo to provide a decorative look to the screen bezel. The arms are attached to the front sides of the screen bezel and protects same from physical damage while customizing the look. The foam material of the screen bezel cover prevents the television from overheating and does not impede the remote control operation and speaker sound of the display.

In this manner, the novel decorative television frame also referred to as a display device screen bezel cover of the present invention accomplishes all of the forgoing objectives, and provides a relatively safe, easy and convenient solution to enhance and customize the look of the conventional television of the users. The decorative television frame utilizes a foam material, that makes the frame light-weight and portable, and allows the users to easily attach the frame to the television screen bezels in order to change the look of the televisions. Additionally, the foam-based decorative television frame of the present invention prevents the television from quickly getting overheated and allows the users to watch different shows, movies, educational shows and more for longer periods of time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a display device screen bezel cover. The display device screen bezel cover device is configured to be a decorative frame and positioned on the front viewing surface of the screen bezel to provide a customized look to the screen bezel. The display device bezel cover further comprises four generally rectangular arm lengths or perimeter sections made up of a soft material. Each arm or perimeter section includes a front viewing surface and a rear mounting surface. The rear mounting surface includes a plurality of self-adhesive tapes along the length of the arm or perimeter section to removably attach to the screen bezel edge. The front viewing surface includes a design or a logo to provide a decorative look to the screen bezel. The arms are attached to the front sides of the screen bezel and protect same from physical damage while customizing the look of the bezel. The foam material of the screen bezel cover prevents the display from overheating, while also not impeding the remote control operation and speaker sound of the television.

In a further embodiment of the present invention, a foam frame for a television display boundary or screen bezel is disclosed. The foam frame includes four separate longitudinal arms or bezel perimeter sections configured to be placed on the front viewing surface or edges of a screen bezel enclosing the television display. Each arm or perimeter section can be made of a flexible and soft material such as foam or silicone. Each perimeter section includes a rear mounting surface and a front viewing surface. The rear mounting surface includes a plurality of self-adhesive tape portions for attaching the arm to a section of the screen bezel and the front viewing surface includes a customized design to provide an aesthetic appeal to the plain bezel of the television. The self-adhesive tape can be continuous along the length of the arm or perimeter section.

In a further embodiment of the present invention, a roll of generally rectangular screen bezel cover is disclosed. The screen bezel cover can be made of a soft material and is configured to attach to the screen bezel surface of a television or any device with a screen bezel. The screen bezel cover roll includes perforated tearing lines to facilitate tearing of the cover to a desired length in order to size the screen bezel to a particular device. The screen bezel cover includes an adhesive tape to enable attachment of the screen bezel cover to the screen bezel surface. Perforation lines in the roll, as described, can be produced using any art recognized in perforation systems. For example, perforation systems can include one or more blades comprising a number of teeth. The cover roll uses a continuous sheet roll in which perforations at predetermined intervals are provided in advance on a continuous sheet of a material, such as a foam cover sheet, a silicone cover sheet or the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a display device bezel cover of the present invention in accordance with the disclosed architecture;

FIG. 2 illustrates a rear plan view of one of the arms or perimeter sections of the display device front boundary cover of the present invention in accordance with the disclosed architecture;

FIG. 3 illustrates a perspective view showing the television bezel display cover of the present invention attached to the screen bezel or front boundary in accordance with the disclosed architecture;

FIG. 4 illustrates a plan view showing the screen bezel display cover of the present invention attached to the screen bezel or front boundary of a display screen in accordance with the disclosed architecture;

FIG. 5 illustrates a cross section view of one of the arms or perimeter sections of the display device boundary cover of the present invention in accordance with the disclosed architecture; and

FIG. 6 illustrates a plan view showing the screen bezel display cover of the present invention packaged in a roll in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that allows the users to change the look of their televisions as per their desires. There is also a long felt need in the art for a device that allows the users to decorate and customize the look of the conventional television installed in any room of home. Additionally, there is a long felt need in the art for a device that allows the users to personalize the look of the television to match to the interior décor of the room. Moreover, there is a long felt need in the art for a device that allows the users to change the plain and simple look of televisions in a convenient manner. Further, there is a long felt need in the art for a device that eliminates the need to buy a new television to have an enhanced appearance of the television. Furthermore, there is a long felt need in the art for a device that prevents the television from getting overheated and allows the users to easily watch their favorite shows for longer periods of time. Finally, there is a long felt need in the art for a device that is portable, easy to use, and provides a convenient solution for people to express themselves through home decoration.

The present invention, in one exemplary embodiment, is a novel display device bezel cover. The display device screen bezel cover is configured to be a decorative frame and positioned on the front viewing surface of the screen bezel to provide a customized look to the screen bezel. The display device bezel cover further comprises four generally rectangular arm lengths or perimeter sections made up of a soft material. Each arm or perimeter section includes a front viewing surface and a rear mounting surface. The rear mounting surface includes a plurality of self-adhesive tapes along the length of the arm or perimeter section to removably attach to the screen bezel edge. The front viewing surface includes a design or a logo to provide decorative look to the screen bezel. The arms are attached to the front sides of the screen bezel and protect same from physical damage while customizing the look of the bezel. The foam material of the screen bezel cover prevents the display from overheating, while also not impeding the remote control operation and speaker sound of the television.

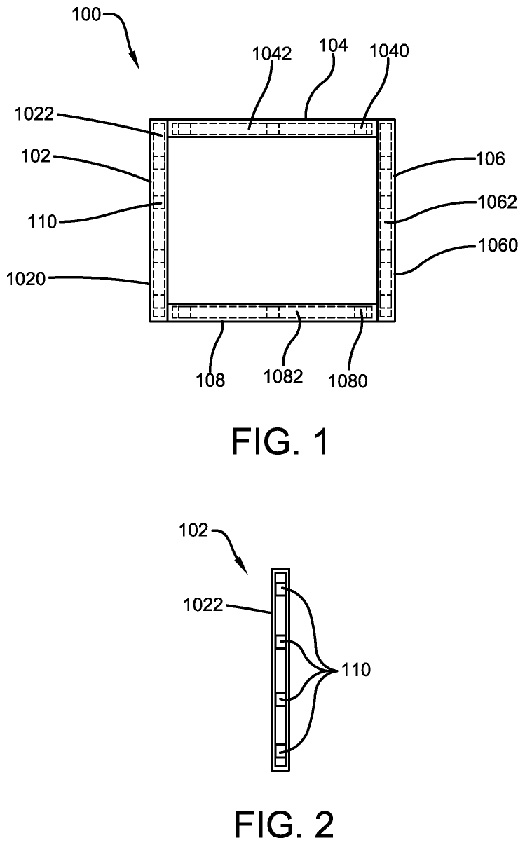

Referring initially to the drawings, FIG. 1 illustrates a perspective view of one potential embodiment of a display device bezel cover of the present invention in accordance with the disclosed architecture. The display device bezel cover 100 of the present invention is configured and designed to be applied to the screen bezel frame surrounding a display screen. Typically, a display screen, such as a television or a desktop screen, includes a boundary or bezel around the screen which is plain, boring and uninspiring. A user looking at the display can become bored easily and the boundary frame may not be consistent with the décor of a room in which the display screen is placed. The display boundary cover 100 is removably attached to the front or exterior surface of the screen bezel or screen boundary frame that surrounds the display.

The display bezel cover 100 can include four separate and distinct arms or perimeter sections 102, 104, 106, 108 made up of a flexible and soft material. Each arm includes a front viewing surface and a rear mounting surface. The rear mounting surface is configured to touch the boundary of the display screen (i.e. the screen bezel) and the front viewing surface is displayed to a user looking at the display screen. The arms 102, 104, 106, 108 are dimensioned to be positioned along the length and the width of the boundary frame of a display screen. In the present embodiment, a first arm 102 and a third arm 106 are dimensioned to position on and cover a front viewing surface of longitudinal side boundaries of the display screen bezel. A second arm 104 and a fourth arm 108 are dimensioned to position on and cover a front viewing surface of top and bottom boundaries of the display screen bezel.

The first arm 102 includes a front viewing surface 1020 and a rear mounting surface 1022. The second arm 104 includes a front viewing surface 1040 and a rear mounting surface 1042. The third arm 106 includes a front viewing surface 1060 and a rear mounting surface 1062. The fourth arm 108 includes a front viewing surface 1080 and a rear mounting surface 1082. The front viewing surfaces are shown in solid lines and the rear mounting surfaces are shown in dashed lines.

Each arm 102, 104, 106, 108 includes self-adhesive tapes 110 attached to the rear mounting surface. The self-adhesive tapes 110 can be permanently attached to the rear mounting surface. Further, the adhesive tapes 110 are attached along the length of each arm to removably attach the arms 102, 104, 106, 108 to the boundary of the display or screen bezel. The self-adhesive tapes 110 can be made of an optical clear adhesive (OCA), resin, a pressure-sensitive adhesive or an ultraviolet light cured adhesive. The adhesive tape 110 can be anti-scratch and does not leave any mark on the boundary of the display when the arms are removed.

Each arm 102, 104, 106, 108 can have any logo, trademark, embroidery, or design on the front viewing surface to enhance and customize the appearance of the display device. The adhesive tapes 110 allow the arms 102, 104, 106, 108 to adhere securely to the exterior or front viewing surface of the boundary or screen bezel to personalize the look of a television or any other display device with a boundary and offers a fun and convenient way for people to express themselves through home decoration.

The material of the arms 102, 104, 106, 108 prevents the display device from getting overheated. The arms 102, 104, 106, 108 are machine washable and protect the display edges/boundary from damages and provide a new colorful look to the display device. Further, the display cover 100 protects the screen bezel from dust, dirt and debris. The display cover 100 is ideal for all types of display devices with a boundary or bezel. A plain and boring screen bezel can be converted to a colorful and/or décor-matching boundary using the arms 102, 104, 106, 108 of the cover 100.

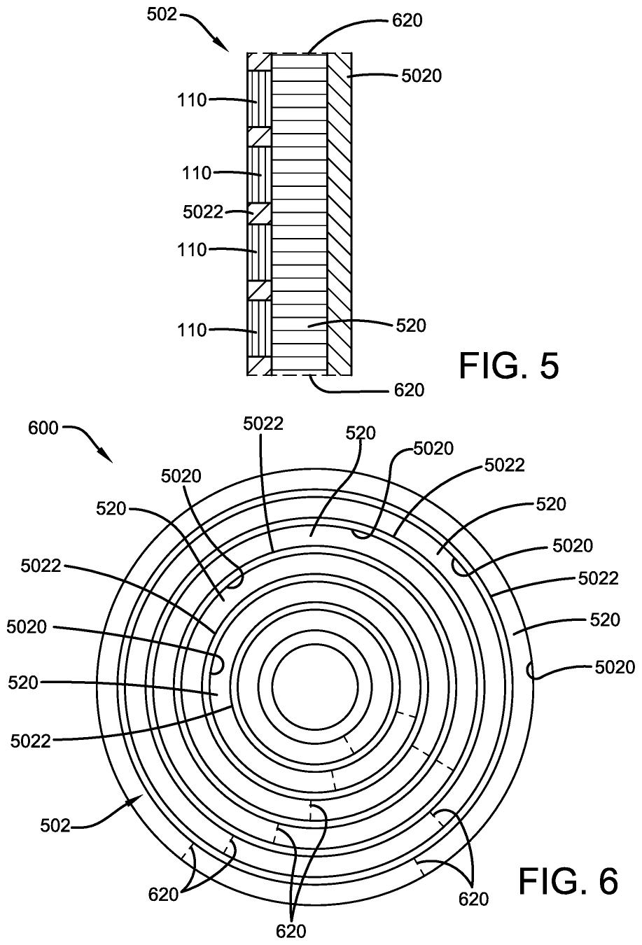

The display cover 100 can be commercially available for different televisions or other display devices. Each commercially available package contains at least four arms of different sizes configured to be positioned on the front boundary of the display device. The display cover can also be available in the form of a roll 600 with tear perforations 620 at distinct lengths allowing a user to apply the cover on multiple televisions or display devices of different dimensions (refer to FIGS. 5 and 6).

FIG. 2 illustrates a rear plan view of one of the arms or sections of the display device front boundary cover of the present invention in accordance with the disclosed architecture. In the present embodiment, a rear plan view of the first arm 102 is illustrated. It should be noted that the configuration of the rear view of the other arms shown in FIG.1 is similar to that of the first arm 102. The rear mounting surface 1022 of the first arm 102 includes a plurality of adhesive tapes 110 allowing the arm 102 to be removably attached to a portion of the screen bezel of the display screen. The adhesive tape can be in discrete sections or can be continuous along the length of the arms 102.

In one potential embodiment, the width of the arm 102 can be up to about 4.0 inches to cover the width of a longitudinal edge of a screen bezel. Alternatively, the width of the arm 102 can be in the range of 1.0 inch. It should be appreciated that the length and width of the arms can be customized to cover bezels of varying dimensions and designs, such as, televisions and computer monitors.

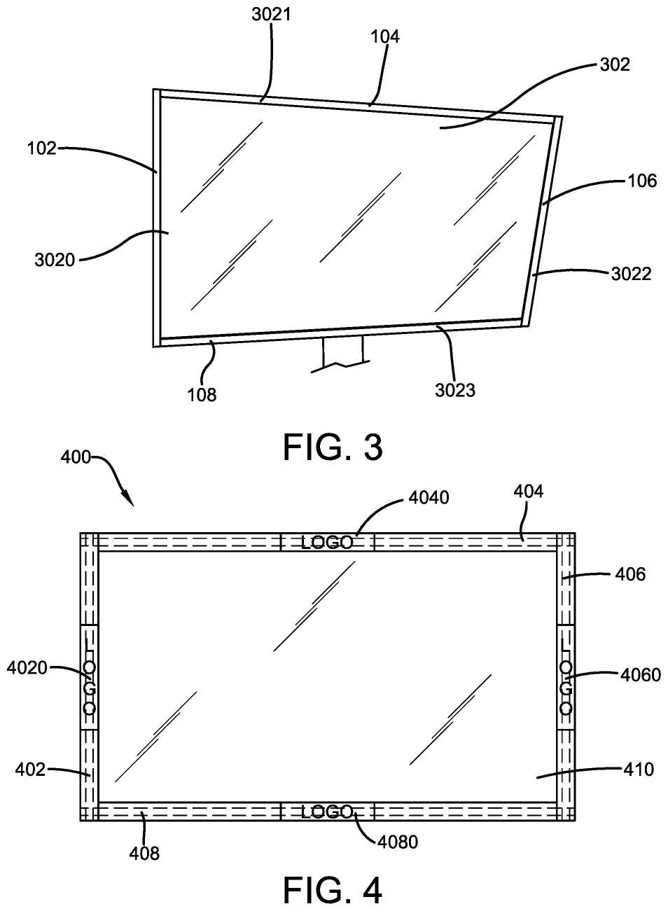

FIG. 3 illustrates a perspective view showing the television bezel display cover of the present invention attached to the screen bezel or front boundary in accordance with the disclosed architecture. Individual sections or arms 102, 104, 106, 108 of the screen bezel cover are attached to the length and width of the screen bezel to make the television 302 more attractive and personalized. The first arm 102 is attached to a first longitudinal edge 3020 of the screen bezel, the second arm 104 is attached to a top bezel edge 3021, the third arm 106 is attached to the other longitudinal edge 3022 of the screen bezel and the fourth arm 108 is attached to the bottom edge 3023 of the screen bezel. The screen bezel cover 100 prevents overheating of the screen bezel and also does not impede the sound of the speakers if the speakers are present on the screen bezel. All the arms are attached using self-adhesive tapes which can be easily removed from the screen bezel as per user preferences.

FIG. 4 illustrates a plan view showing the screen bezel display cover of the present invention attached to the screen bezel or front boundary of a display screen in accordance with the disclosed architecture. Each cover arm of the present embodiment of the screen bezel cover 400 can include a logo to provide a customized look. The display screen 410 of the present embodiment can be a desktop computer monitor, a television, or any display device with a bezel. The first arm 402 can include a front viewing surface 4020 and can be attached to the screen bezel using self-adhesive tapes. Similarly, the second arm 404 can include a logo 4040 for a top portion of the bezel, the third arm 406 can include a logo 4060 for the other edge of the screen bezel, and the fourth arm 408 can include a logo 4080 for the bottom edge of the screen bezel. The logos 4020, 4040, 4060, 4080 can be customized and can be a brand name or an advertisement. The arms 402, 404, 406, 408 can alternatively include colors or patterns to match a desired decor. It is to be appreciated that the arms 402, 404, 406, 408 can be provided in various sizes and designs to customize and personalize the appearance of a television screen or computer monitor.

FIG. 5 illustrates a cross-section view of another embodiment of one of the arms or sections of the display device front boundary cover of the present invention in accordance with the disclosed architecture. As illustrated, a first arm 502 can include a foam layer 520 between the front viewing surface 5020 and the rear mounting surface 5022. The foam layer 520 can include a thickness generally from about 0.25 inches to about 1.25 inches. The thickness and structure of the foam layer 520 provides for a semi-rigid configuration to the arm sections and forms a foam frame around the screen bezel that provides depth and relief between the arm sections and the screen. The foam frame can include four separate longitudinal arms or bezel perimeter sections configured to be placed on the front viewing surface or edges of a screen bezel enclosing the television display. Each arm or perimeter section, as illustrated in FIG. 5, can be made of a flexible and soft material such as the foam or a silicone. The foam material of the screen bezel cover prevents the display from overheating, while also not impeding the remote control operation and speaker sound of the television. Each perimeter section includes a rear mounting surface and a front viewing surface. The rear mounting surface includes a plurality of self-adhesive tape portions for attaching the arm to a section of the screen bezel and the front viewing surface includes a customized design to provide an aesthetic appeal to the plain bezel of the television. The self-adhesive tape can be continuous along the length of the arm or perimeter section, or can be applied in discrete sections.

FIG. 6 illustrates a plan view of a roll package of another embodiment of the arms or sections of the display device front boundary cover of the present invention in accordance with the disclosed architecture. As illustrated, a rolled package 600 includes a continuous length of arm section 502. The arm section comprises the foam layer 520 between the front viewing surface 5020 and the rear mounting surface 5022.

The screen bezel protective cover may be made available in different sizes and colors to accommodate user needs and/or preferences. The particular size, measurement, construction and design specifications of the cover 100, 400, 600 of the present invention may vary upon manufacturing or the particular material that is used. As stated supra, each arm of the cover can further comprise logos, indicia, trademarks, geometric patterns, customizable colors, fonts, prints and/or images on the front viewing surface thereof.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “display device bezel cover”, “bezel display cover”, “television bezel display cover”, “display cover”, “screen bezel cover”, and “cover” are interchangeable and refer to the display device bezel cover 100 of the present invention.

Notwithstanding the forgoing, the display device bezel cover 100, 400, 600 of the present invention can be of any suitable size and configuration as is known in the art without affecting the overall concept of the invention, provided that it accomplishes the above-stated objectives. One of ordinary skill in the art will appreciate that the size, configuration, and material of the display device bezel cover 100, 400, 600 as shown in the FIG. are for illustrative purposes only, and that many other sizes and shapes of the display device bezel cover 100, 400, 600 are well within the scope of the present disclosure. Although the dimensions of the display device bezel cover 100, 400, 600 are important design parameters for user convenience, the display device bezel cover 100, 400, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A screen bezel cover for an electronic device, the screen bezel cover comprising:
a plurality of rectilinear arm sections each having a rear mounting surface and a front viewing surface, wherein the front viewing surface comprises a customizable viewing area;
a foam layer positioned between said rear mounting surface and said front viewing surface;
said rear mounting surface includes an adhesive tape area for mounting to an electronic screen bezel;
each said arm section including a series of perforated lines thereacross; and
said series of perforated lines are used to selectively size each of said plurality of rectilinear arm sections.

2. The screen bezel cover of claim 1, wherein said adhesive tape area is discrete.

3. The screen bezel cover of claim 1, wherein said adhesive tape area is continuous.

4. The screen bezel cover of claim 1, wherein said plurality of rectilinear arm sections are separated at a desired length from a continuous roll.

5. The screen bezel cover of claim 4, wherein each of said plurality of rectilinear arm sections comprise a width generally from about 1.0 inch to about 4.0 inches.

6. The screen bezel cover of claim 5, wherein each of said plurality of rectilinear arm sections comprise a thickness generally from about 0.25 inches to about 1.25 inches.

7. The screen bezel cover of claim 6, wherein said adhesive tape is selected from a group consisting of an optical clear adhesive, a resin adhesive, a pressure sensitive adhesive and an ultraviolet light cured adhesive.

8. The screen bezel cover of claim 6, wherein said customizable viewing area coordinates with an interior decor of a room.

9. The screen bezel cover of claim 6, wherein said customizable viewing area includes a logo.

10. A screen bezel cover comprising:
a plurality of rectilinear arm sections separated at a desired length from a continuous roll along a series of perforations, wherein said series of perforations provide a tearing line for selectively sizing each of said plurality of rectilinear arm sections;
a rear mounting surface and a front viewing surface on each of said plurality of rectilinear arm sections, wherein said front viewing surface includes a customizable viewing area;
a foam layer positioned between said rear mounting surface and said front viewing surface; and
an adhesive tape area positioned on said rear mounting surface for mounting the screen bezel cover to an electronic screen bezel.

11. The screen bezel cover of claim 10, wherein said adhesive tape area is discrete.

12. The screen bezel cover of claim 10, wherein said adhesive tape area is continuous.

13. The screen bezel cover of claim 10, wherein said plurality of rectilinear arm sections comprise a width generally from about 1.0 inch to about 4.0 inches.

14. The screen bezel cover of claim 13, wherein said plurality of rectilinear arm sections comprise a thickness generally from about 0.25 inches to about 1.25 inches.

15. The screen bezel cover of claim 14, wherein said adhesive tape area is selected from a group consisting of an optical clear adhesive, a resin adhesive, a pressure sensitive adhesive and an ultraviolet light cured adhesive.

16. The screen bezel cover of claim 14, wherein said customizable viewing area coordinates with an interior decor of a room.

17. The screen bezel cover of claim 14, wherein said customizable viewing area comprises a logo.

18. A method of covering an electronic screen bezel, the method comprising the steps of:
providing a continuous roll containing a plurality of rectilinear arm sections;
separating an individual rectilinear arm section at a desired length from said continuous roll and along a selected perforated line thereacross;
tearing along said selected perforated line for selectively sizing the individual rectilinear arm section;
said plurality of rectilinear arm sections each include a rear mounting surface, a front viewing surface, and a foam layer positioned between said rear mounting surface and said front viewing surface;
customizing said front viewing surface with a color to coordinate with a room decor; and
adhering at least one rectilinear arm section to each side of the electronic screen bezel to frame the electronic screen bezel with said plurality of rectilinear arm sections.

19. The method of claim 18, wherein each of the plurality of rectilinear arm sections comprise an adhesive tape secured to said rear mounting surface and the electronic screen bezel.

20. The method of claim 19, wherein each of said plurality of rectilinear arm sections comprise a width generally from about 1.0 inch to about 4.0 inches, and a thickness generally from about 0.25 inches to about 1.25 inches.
